(19) United States
(12) Patent Application Publication
(10) Pub. No.: US 2025/0361353 A1
(43) Pub. Date: Nov. 27, 2025

(54) Curable Photochromic Compositions Including Isocyanate and Imine Functional Components

(71) Applicant: Transitions Optical, Ltd., Tuam (IE)

(72) Inventors: Ramaiahgari Amaranatha Reddy, Murrysville, PA (US); Anil Kumar, Murrysville, PA (US)

(21) Appl. No.: 18/873,752

(22) PCT Filed: Jun. 29, 2022
(86) PCT No.: PCT/EP2022/067924

§ 371 Date: Dec. 11, 2024

(51) Int. Cl. C08G 18/80; C08G 18/00; C08G 18/64; C09K 9/02

(52) U.S. Cl. CPC C08G 18/80; C08G 18/003; C08G 18/6423; C09K 9/02; C09K 2211/1022

(57) ABSTRACT

The present invention relates to, a curable photochromic composition that includes: (a) a photochromic compound; (b) a polyisocyanate including at least two isocyanate groups; and (c) a reactive component having at least two reactive groups that are each reactive with the isocyanate groups of the polyisocyanate. Each reactive group of the reactive component is independently selected from primary amine and imine, provided that at least one reactive group of the reactive component is selected from imine. The curable photochromic composition further includes (d) a non-reactive component that is free of functional groups that are reactive with the polyisocyanate and said reactive component. The present invention also relates to an article that includes: a substrate; and a photochromic layer over at least one surface of the substrate, where the photochromic layer is formed from the curable photochromic composition of the present invention.

### FIELD

The present invention relates to curable photochromic compositions, which include, a photochromic compound, a polyisocyanate, a reactive component having imine groups and optionally primary amine groups, and a non-reactive component that is free of functional groups that are reactive with the polyisocyanate and the reactive component.

### BACKGROUND

In response to certain wavelengths of electromagnetic radiation (or “actinic radiation”), photochromic compounds, such as indeno-fused naphthopyrans, typically undergo a transformation from one form or state to another form, with each form having a characteristic or distinguishable absorption spectrum associated therewith. Typically, upon exposure to actinic radiation, many photochromic compounds are transformed from a closed-form, which corresponds to an unactivated (or bleached, e.g., substantially colorless) state of the photochromic compound, to an open-form, which corresponds to an activated (or colored) state of the photochromic compound. In the absence of exposure to actinic radiation, such photochromic compounds are reversibly transformed from the activated (or colored) state, back to the unactivated (or bleached) state. Compositions and articles, such as optical lenses, that contain photochromic compounds or have photochromic compounds applied thereto (e.g., in form of a photochromic coating composition) typically display colorless (e.g., clear) and colored states that correspond to the colorless and colored states of the photochromic compounds contained therein or applied thereto.

Photochromic compounds can be used in curable compositions to form, for example, cured layers, such as cured films or sheets that are photochromic. With cured photochromic films, such as cured photochromic coatings, it is typically desirable that they provide a combination of hardness and photochromic performance. Generally, the kinetics associated with the reversible transformation of a photochromic compound between a closed-form (unactivated/colorless) and an open-form (activated/colored) is faster in a soft matrix, but slower in a hard matrix (of the cured film in which the photochromic compound resides). Cured photochromic films having a soft matrix typically have reduced hardness, while those having a hard matrix typically have increased hardness.

It would be desirable to develop curable photochromic compositions that provide cured photochromic layers having improved hardness without a reduction in photochromic performance.

### SUMMARY

In accordance with the present invention, there is provided a curable photochromic composition comprising: (a) a photochromic compound; (b) a polyisocyanate comprising at least two isocyanate groups; (c) a reactive component comprising at least two reactive groups that are each reactive with isocyanate groups, wherein each reactive group of the reactive component is independently selected from primary amine and imine, provided that at least one reactive group of the reactive component is selected from imine; and (d) a non-reactive component. The non-reactive component is free of functional groups that are reactive with said polyisocyanate and said reactive component.

In accordance with the present invention, there is further provided an article comprising: (A) a substrate; and (B) a photochromic layer over at least one surface of the substrate, wherein the photochromic layer is formed from the curable photochromic composition of the present invention, as described above and further herein.

The features that characterize the present invention are pointed out with particularity in the claims, which are annexed to and form a part of this disclosure. These and other features of the invention, its operating advantages and the specific objects obtained by its use will be more fully understood from the following detailed description in which non-limiting embodiments of the invention are illustrated and described.

### DETAILED DESCRIPTION

As used herein, the articles “a,” “an,” and “the” include plural referents unless otherwise expressly and unequivocally limited to one referent.

Unless otherwise indicated, all ranges or ratios disclosed herein are to be understood to encompass any and all values, and subranges or subratios subsumed therein. For example, a stated range or ratio of “1 to 10” should be considered to include: any and all values there-between, including the stated terminal values (such as 1, 2, 3, 4, 5, 6, 7, 8, 9, and 10); and subranges between (and inclusive of) the minimum value of 1 and the maximum value of 10, that is, all subranges or subratios beginning with a minimum value of 1 or more and ending with a maximum value of 10 or less, such as but not limited to, 1 to 6.1, 3.5 to 7.8, and 5.5 to 10.

As used herein, unless otherwise indicated, left-to-right representations of linking groups, such as divalent linking groups, are inclusive of other appropriate orientations, such as, but not limited to, right-to-left orientations. For purposes of non-limiting illustration, the left-to-right representation of the divalent linking group

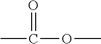

or equivalently —C(O)O—, is inclusive of the right-to-left representation thereof,

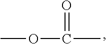

or equivalently —O(O)C— or —OC(O)—.

Other than in the operating examples, or where otherwise indicated, all numbers expressing quantities of ingredients, reaction conditions, and so forth used in the specification and claims are to be understood as modified in all instances by the term “about.”

As used herein, molecular weight values of polymers, such as weight average molecular weights (Mw) and number average molecular weights (Mn), are determined by gel permeation chromatography (GPC) using appropriate standards, such as polystyrene standards.

As used herein, polydispersity index (PDI) values represent a ratio of the weight average molecular weight (Mw) to the number average molecular weight (Mn) of the polymer (i.e., Mw/Mn).

As used herein, the term “polymer” means homopolymers (e.g., prepared from a single monomer species), copolymers (e.g., prepared from at least two monomer species), and graft polymers.

As used herein, the term “(meth)acrylate” and similar terms, such as “(meth)acrylic acid ester” means methacrylates and/or acrylates. As used herein, the term “(meth)acrylic acid” means methacrylic acid and/or acrylic acid.

As used herein, the term “photochromic” and similar terms, such as “photochromic compound” means having an absorption spectrum for at least visible radiation that varies in response to absorption of at least actinic radiation. Further, as used herein the term “photochromic material” means any substance that is adapted to display photochromic properties (such as, adapted to have an absorption spectrum for at least visible radiation that varies in response to absorption of at least actinic radiation) and which includes at least one photochromic compound.

As used herein, the term “actinic radiation” means electromagnetic radiation that is capable of causing a response in a material, such as, but not limited to, transforming a photochromic material from one form or state to another as will be discussed in further detail herein.

As used herein, the term “photochromic material” includes thermally reversible photochromic materials and compounds and non-thermally reversible photochromic materials and compounds. The term “thermally reversible photochromic compounds/materials” as used herein means compounds/materials capable of converting from a first state, for example a “clear state,” to a second state, for example a “colored state,” in response to actinic radiation, and reverting back to the first state in response to thermal energy. The term “non-thermally reversible photochromic compounds/materials” as used herein means compounds/materials capable of converting from a first state, for example a “clear state,” to a second state, for example a “colored state,” in response to actinic radiation, and reverting back to the first state in response to actinic radiation of substantially the same wavelength(s) as the absorption(s) of the colored state.

As used herein to modify the term “state,” the terms “first” and “second” are not intended to refer to any particular order or chronology, but instead refer to two different conditions or properties. For purposes of non-limiting illustration, the first state and the second state of a photochromic compound can differ with respect to at least one optical property, such as but not limited to the absorption of visible and/or UV radiation. Thus, according to various non-limiting embodiments disclosed herein, the photochromic compounds of the present invention can have a different absorption spectrum in each of the first and second states. For example, while not limiting herein, a photochromic compound of the present invention can be clear in the first state and colored in the second state. Alternatively, a photochromic compound of compositions of the present invention can have a first color in the first state and a second color in the second state.

As used herein the term “optical” means pertaining to or associated with light and/or vision. For example, according to various non-limiting embodiments disclosed herein, the optical article or element or device can be chosen from ophthalmic articles, elements and devices, display articles, elements and devices, windows, mirrors, and active and passive liquid crystal cell articles, elements and devices.

As used herein the term “ophthalmic” means pertaining to or associated with the eye and vision. Non-limiting examples of ophthalmic articles or elements include corrective and non-corrective lenses, including single vision or multi-vision lenses, which can be either segmented or non-segmented multi-vision lenses (such as, but not limited to, bifocal lenses, trifocal lenses and progressive lenses), as well as other elements used to correct, protect, or enhance (cosmetically or otherwise) vision, including without limitation, contact lenses, intra-ocular lenses, magnifying lenses, and protective lenses or visors.

As used herein the term “display” means the visible or machine-readable representation of information in words, numbers, symbols, designs or drawings. Non-limiting examples of display elements include screens, monitors, and security elements, such as security marks.

As used herein the term “window” means an aperture adapted to permit the transmission of radiation there-through. Non-limiting examples of windows include automotive and aircraft transparencies, windshields, filters, shutters, and optical switches.

As used herein the term “mirror” means a surface that specularly reflects a large fraction of incident light.

As used herein the term “liquid crystal cell” refers to a structure containing a liquid crystal material that is capable of being ordered. A non-limiting example of a liquid crystal cell element is a liquid crystal display.

As used herein, spatial or directional terms, such as “left”, “right”, “inner”, “outer”, “above”, “below”, and the like, relate to various orientations of the invention as may be described further herein, such as articles and multilayer articles of the present invention. It is to be understood, however, that the invention can assume various alternative orientations to those described herein and, accordingly, such terms are not to be considered as limiting.

As used herein, the terms “formed over,” “deposited over,” “provided over,” “applied over,” residing over,” or “positioned over,” mean formed, deposited, provided, applied, residing, or positioned on but not necessarily in direct (or abutting) contact with the underlying element, or surface of the underlying element. For example, a layer “positioned over” a substrate does not preclude the presence of one or more other layers, coatings, or films of the same or different composition located between the positioned or formed layer and the substrate.

All documents, such as but not limited to issued patents and patent applications, referred to herein, and unless otherwise indicated, are to be considered to be “incorporated by reference” in their entirety.

As used herein, recitations of “linear or branched” groups, such as linear or branched alkyl, are herein understood to include: a methylene group or a methyl group; groups that are linear, such as linear C₂-C₂₀ alkyl groups; and groups that are appropriately branched, such as branched C₃-C₂₀ alkyl groups.

The term “alkyl” as used herein means linear or branched, cyclic or acyclic C₁-C₂₅ alkyl. Linear or branched alkyl can include C₁-C₂₅ alkyl, such as C₁-C₂₀ alkyl, such as C₂-C₁₀ alkyl, such as C₁-C₁₂ alkyl, such as C₁-C₆ alkyl. Examples of alkyl groups from which the various alkyl groups of the present invention can be selected from, include, but are not limited to, those recited further herein. Alkyl groups can include “cycloalkyl” groups. The term “cycloalkyl” as used herein means groups that are appropriately cyclic, such as, but not limited to, C₃-C₁₂ cycloalkyl (including, but not limited to, cyclic C₃-C₁₀ alkyl, or cyclic C₅-C₇ alkyl) groups. Examples of cycloalkyl groups include, but are not limited to, those recited further herein. The term “cycloalkyl” as used herein also includes: bridged ring polycycloalkyl groups (or bridged ring polycyclic alkyl groups), such as, but not limited to, bicyclo[2.2.1]heptyl (or norbornyl) and bicyclo[2.2.2]octyl; and fused ring polycycloalkyl groups (or fused ring polycyclic alkyl groups), such as, but not limited to, octahydro-1H-indenyl, and decahydronaphthalenyl.

The term “heterocycloalkyl” as used herein means groups that are appropriately cyclic, such as, but not limited to, C₂-C₁₂ heterocycloalkyl groups, such as C₂-C₁₀ heterocycloalkyl groups, such as C₅-C₇ heterocycloalkyl groups, and which have at least one hetero atom in the cyclic ring, such as, but not limited to, O, S, N, P, and combinations thereof. Examples of heterocycloalkyl groups include, but are not limited to, imidazolyl, tetrahydrofuranyl, tetrahydropyranyl and piperidinyl. The term “heterocycloalkyl” as used herein also includes: bridged ring polycyclic heterocycloalkyl groups, such as, but not limited to, 7-oxabicyclo[2.2.1]heptanyl; and fused ring polycyclic heterocycloalkyl groups, such as, but not limited to, octahydrocyclopenta[b]pyranyl, and octahydro-1H-isochromenyl.

The descriptions, classes, and examples provided herein with regard to alkyl groups, cycloalkyl groups, heterocycloalkyl groups, haloalkyl groups, and the like, are also applicable to alkane groups, cycloalkane groups, heterocycloalkane groups, haloalkane groups, etc., such as, but not limited to, polyvalent alkane groups, such as polyvalent alkane linking groups, such as divalent alkane linking groups.

As used herein, the term “aryl” and related terms, such as “aryl group”, means an aromatic cyclic monovalent hydrocarbon radical. As used herein, the term “aromatic” and related terms, such as “aromatic group,” means a cyclic conjugated hydrocarbon having stability (due to delocalization of pi-electrons) that is significantly greater than that of a hypothetical localized structure. Examples of aryl groups include C₆-C₁₄ aryl groups, such as, but not limited to, phenyl, naphthyl, phenanthryl, and anthracenyl.

The term “heteroaryl”, as used herein, includes, but is not limited to, C₃-C₁₈ heteroaryl, such as, but not limited to, C₃-C₁₀ heteroaryl (including fused ring polycyclic heteroaryl groups) and means an aryl group having at least one hetero atom in the aromatic ring, or in at least one aromatic ring in the case of a fused ring polycyclic heteroaryl group. Examples of heteroaryl groups include, but are not limited to, furanyl, pyranyl, pyridinyl, quinolinyl, isoquinolinyl, and pyrimidinyl.

The term “aralkyl”, as used herein, includes, but is not limited to, C₆-C₂₄ aralkyl, such as, but not limited to, C₆-C₁₀ aralkyl, and means an alkyl group substituted with an aryl group. Examples of aralkyl groups include, but are not limited to, benzyl and phenethyl.

Representative alkyl groups include, but are not limited to, methyl, ethyl, propyl, isopropyl, butyl, isobutyl, sec-butyl, tert-butyl, pentyl, neopentyl, hexyl, heptyl, octyl, nonyl and decyl. Representative alkenyl groups include, but are not limited to, vinyl, allyl, and propenyl. Representative alkynyl groups include, but are not limited to, ethynyl, 1-propynyl, 2-propynyl, 1-butynyl, and 2-butynyl. Representative cycloalkyl groups include, but are not limited to, cyclopropyl, cyclobutyl, cyclopentyl, cyclohexyl, and cyclooctyl.

As used herein, the term “halo” and related terms, such as “halo group,” “halo substituent,” “halogen group,” and “halogen substituent,” means a single bonded halogen group, such as —F, —Cl, —Br, and —I.

As used herein, recitations of “halo substituted” and related terms (such as, but not limited to, haloalkyl groups, haloalkenyl groups, haloalkynyl groups, haloaryl groups, and halo-heteroaryl groups) means a group in which at least one, and up to and including all of the available hydrogen groups thereof is substituted with a halo group, such as, but not limited to F, Cl or Br. The term “halo-substituted” is inclusive of “perhalo-substituted.”

As used herein, “at least one of” is synonymous with “one or more of,” whether the elements are listed conjunctively or disjunctively. For example, the phrases “at least one of A, B, and C” and “at least one of A, B, or C” each mean any one of A, B, or C, or any combination of any two or more of A, B, or C. For example, A alone; or B alone; or C alone; or A and B; or A and C; or B and C; or all of A, B, and C.

As used herein, “selected from” is synonymous with “chosen from” whether the elements are listed conjunctively or disjunctively. Further, the phrases “selected from A, B, and C” and “selected from A, B, or C” each mean any one of A, B, or C, or any combination of any two or more of A, B, or C. For example, A alone; or B alone; or C alone; or A and B; or A and C; or B and C; or all of A, B, and C.

As used herein, and in accordance with some embodiments, the term “ester” such as with regard to groups, and substituents of various groups, of the compounds and components of the present invention, and related terms, such as “ester group” and “ester substituent” means a carboxylic acid ester group represented by —C(O)OR, where R is selected from those groups as described below, other than hydrogen.

As used herein, and in accordance with some embodiments, the term “carbonate” such as with regard to groups, and substituents of various groups, of the compounds and components of the present invention, and related terms, such as “carbonate group” and “carbonate substituent” includes a material represented by —OC(O)OR, where R is selected from those groups as described below, other than hydrogen.

As used herein, and in accordance with some embodiments, the term “urethane,” such as with regard to groups, and substituents of various groups, of the compounds and components of the present invention, and related terms, such as “urethane group,” and “urethane substituent,” includes a material represented by —OC(O)N(R)(H) or —N(H)C(O)OR, where R in each case is independently selected from those groups as described below, other than hydrogen.

Unless otherwise stated, each R group of each of the above described ketone, ester (carboxylic acid ester), carbonate, and urethane groups, is in each case independently selected from hydrogen, alkyl, haloalkyl, perhaloalkyl, cycloalkyl, heterocycloalkyl, aryl, heteroaryl, and combinations thereof (including those classes and examples thereof as recited previously herein).

The curable photochromic compositions of the present invention include a polyisocyanate that has at least two isocyanate groups. With some embodiments, the polyisocyanate includes 2 to 10 isocyanate groups, or 2 to 8 isocyanate groups, or 2 to 6 isocyanate groups, or 2 to 5 isocyanate groups, or 2 to 4 isocyanate groups. With some embodiments, the polyisocyanate includes at least one of, linear or branched aliphatic polyisocyanates, cycloaliphatic polyisocyanates, biurets thereof, allophanates thereof, isocyanurates thereof, and combinations thereof.

Examples of linear or branched aliphatic polyisocyanates from which the polyisocyanate of the curable photochromic composition can be selected include, but are not limited to: 1,2-diisocyanatoethane (ethylene diisocyanate); tetramethylene-1,4-diisocyanate; hexamethylene-1,6-diisocyanate; 2,2,4-trimethyl hexane-1,6-diisocyanate; 2,4,4-trimethyl hexane-1,6-diisocyanate; and dodecane-1,12-diisocyanate.

Examples of cycloaliphatic polyisocyanates from which the polyisocyanate of the curable photochromic composition can be selected include, but are not limited to: cyclobutane-1,3-diisocyanate; cyclohexane-1,3-diisocyanate; cyclohexane-1,4-diisocyanate; methyl cyclohexyl diisocyanate; hexahydrotoluene-2,4-diisocyanate; hexahydrotoluene-2,6-diisocyanate; hexahydrophenylene-1,3-diisocyanate; hexahydrophenylene-1,4-diisocyanate; perhydrodiphenylmethane-2,4′-diisocyanate; perhydrodiphenylmethane-4,4′-diisocyanate; and norbornane diisocyanate.

The polyisocyanate of the curable photochromic composition, with some embodiments, has an isocyanate equivalent weight of from 95 to 500 g/mole, or from 150 to 400 g/mole, or from 150 to 350 g/mole.

In accordance with some embodiments, at least some isocyanate groups of the polyisocyanate are reversibly blocked (or capped) with a blocking agent (or capping agent).

As used herein, the term “reversibly blocked” and related terms, such as “reversibly capped” with regard to the isocyanate groups of the polyisocyanate, means isocyanate groups thereof that are blocked or capped with a blocking or capping agent. Under controlled conditions, such as exposure to elevated temperature, the blocking/capping agent separates (or deblocks or decaps) from the blocked isocyanate groups, allowing the free/unblocked isocyanate groups thereof to: react and form covalent bonds with the reactive groups of the reactive component. After unblocking or decapping from the blocked isocyanate groups of the polyisocyanate, the blocking/capping agent can volatize out of the curable photochromic composition (prior to the composition becoming vitrified) and/or remain in the curable photochromic composition, such as a plasticizer. With some embodiments, it is desirable that the blocking/capping agent not form bubbles or voids in the curable photochromic composition and/or not overly plasticize the curable photochromic composition after deblocking/decapping.

As used herein, and in accordance with some embodiments, “at least some isocyanate groups of the polyisocyanate being independently and reversibly blocked with a blocking agent,” means at least 10%, or at least 20%, or at least 25%, or at least 50%, or at least 75%, or at least 90%, or at least 95%, or 100% of the isocyanate groups are reversibly blocked.

The blocking/capping groups of the blocked isocyanate groups of the polyisocyanate can be selected from, with some embodiments hydroxy functional compounds, 1H-azoles, lactams, ketoximes, and mixtures thereof. Classes of hydroxy functional compounds include, but are not limited to, aliphatic, cycloaliphatic, or aromatic alkyl monoalcohols or phenolics. Specific examples of hydroxy functional compounds useful as blocking/capping agents, include, but are not limited to: lower aliphatic alcohols such as methanol, ethanol, and n-butanol; cycloaliphatic alcohols such as cyclohexanol and tetrahydrofuran; aromatic-alkyl alcohols, such as phenyl carbinol and methylphenyl carbinol; and glycol ethers, such as ethylene glycol butyl ether, diethylene glycol butyl ether, ethylene glycol methyl ether and propylene glycol methyl ether. With some embodiments, the hydroxy functional blocking/capping groups include phenolics, examples of which include, but are not limited to, phenol itself and substituted phenols, such as cresol, nitrophenol and p-hydroxy methylbenzoate.

Examples of 1H-azoles that are useful as blocking/capping groups include, but are not limited to 1H-imidazole, 1H-pyrazole, 1H-dialkyl pyrazoles (such as, 1H-3,5-dimethyl pyrazole and 1H-2,5-dimethyl pyrazole), 1H-1,2,3-triazole, 1H-1,2,3-benzotriazole, 1H-1,2,4-triazole, 1H-5-methyl-1,2,4-triazole, and 1H-3-amino-1,2,4-triazole.

Ketoximes useful as blocking/capping groups include those prepared from aliphatic or cycloaliphatic ketones. Examples of ketoxime capping groups include, but are limited to, 2-propanone oxime (acetone oxime), 2-butanone oxime (also referred to as, methylethyl ketoxime), 2-pentanone oxime, 3-pentanone oxime, 3-methyl-2-butanone oxime, 4-methyl-2-pentanone oxime, 3,3-dimethyl-2-butanone oxime, 2-heptanone oxime, 3-heptanone oxime, 4-heptanone oxime, 5-methyl-3-heptanone oxime, 2,6-dimethyl-4-heptanone oxime, cyclopentanone oxime, cyclohexanone oxime, 3-methylcyclohexanone oxime, 3,3,5-trimethylcyclohexanone oxime, and 3,5,5-trimethyl-2-cyclohexene-5-one oxime.

Examples of lactam capping groups include, but are not limited to, e-caprolactam and 2-pyrolidinone. Other suitable capping groups include, morpholine, 3-aminopropyl morpholine, and N-hydroxy phthalimide.

With some embodiments of the present invention, the blocked isocyanate groups of the polyisocyanate are each independently blocked with a blocking/capping agent selected from methylethyl ketoxime, pyrazole (more particularly, 1H-pyrazole), and dialkyl pyrazole (more particularly, 1H-dialkyl pyrazole, such as 1H-3,5-dimethyl pyrazole and 1H-2,5-dimethyl pyrazole).

The polyisocyanate, with some embodiments, in present in the curable photochromic composition of the present invention, in an amount of from 40 percent by weight to 90 percent by weight, or from 45 percent by weight to 90 percent by weight, or from 50 percent by weight to 85 percent by weight, the percent weights in each case being based on total resin solids weight.

As used herein, and with regard to the curable photochromic composition, the term “total weight of resin solids” and similar terms, such as “total resin solids weight” and “total resin solids” means the total weight of the polyisocyanate, reactive component, and non-reactive component, and unless otherwise stated, does not include the weight of the photochromic compound(s) and other optional additives.

With some embodiments of the curable photochromic compositions of the present invention, a molar ratio of moles of isocyanate groups of the polyisocyanate to total moles of reactive groups of the reactive component is from 1:1 to 20:1, or from 1:1 to 18:1, or from 1:1 to 17:1, or from 1:1 to 16.5:1.

The curable photochromic compositions of the present invention include a reactive component having at least two reactive groups that are each reactive with isocyanate groups of the polyisocyanate compound. The reactive groups of the reactive component are in each case independently selected from primary amine (—NH₂) and imine. At least one reactive group of the reactive component is selected from imine. With some embodiments, the reactive component has 2 to 25 reactive groups, or 3 to 20 reactive groups, or 4 to 15 reactive groups.

In accordance with some embodiments, the imine groups of the reactive component are represented by the following Formula (B):

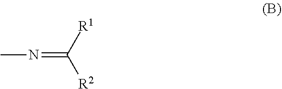

With reference to Formula (B), and in accordance with some embodiments, R¹ and R² are each independently selected from hydrogen (H), linear or branched C₁-C₂₀ alkyl, and cyclic C₃-C₁₀ alkyl, or R¹ and R² together from a cyclic alkyl group having from 3 to 10 carbon atoms in the ring. With some embodiments, at least one of R¹ and R² is other than hydrogen (H). With some further embodiments, R¹ and R² are in each case independently other than hydrogen (H). While not intending to be bound by any theory, it is believed that reaction between imine groups of the reactive component, such as represented by Formula (B), and isocyanate groups of the polyisocyanate, results in the formation of cyclic linkages between the polyisocyanate and the reactive component.

The reactive component with some embodiments includes at least one of aliphatic polyether, aliphatic polyester, aliphatic polycarbonate, aliphatic polyethylenimine, and/or aliphatic polyurethane, each of which independently has at least two reactive groups, which are in each case independently selected from primary amine and imine, provided at least one reactive group is selected from imine.

The aliphatic polyether having at least two reactive groups includes a plurality of ether linkages (—O—), and is free of aromatic groups. With some embodiments, the aliphatic polyether includes a linear or branched C₂-C₂₀ alkyl linkage and/or a C₃-C₁₀ cycloalkyl linkage, independently between and/or extending from each ether linkage. The aliphatic polyether having at least two reactive groups can be prepared in accordance with art recognized methods. With some embodiments, a hydroxyl functional polyether having at least two hydroxyl groups is reacted with an aziridine, which results in the formation of an amine functional polyether intermediate having at least two primary amine groups. At least some of the primary amines of the amine functional polyether intermediate can next be reacted with one or more ketones, which results in the formation of a polyether having imine groups and optionally primary amine groups. The aliphatic polyether having at least two reactive groups, with some embodiments, has an Mn of from 175 g/mole to 20,000 g/mole, or from 200 g/mole to 15,000 g/mole, or from 200 g/mole to 10,000 g/mole.

The aliphatic polyester having at least two reactive groups includes a plurality of carboxylic acid ester linkages (—C(O)—O—), and is free of aromatic groups. With some embodiments, the aliphatic polyester includes a linear or branched C₂-C₂₀ alkyl linkage and/or a C₃-C₁₀ cycloalkyl linkage, independently between and/or extending from each carboxylic acid ester linkage. The aliphatic polyester having at least two reactive groups can be prepared in accordance with art recognized methods. With some embodiments, a hydroxyl functional polyester having at least two hydroxyl groups is reacted with an aziridine, which results in the formation of an amine functional polyester intermediate having at least two primary amine groups. At least some of the primary amines of the amine functional polyester intermediate can next be reacted with one or more ketones, which results in the formation of a polyester having imine groups and optionally primary amine groups. In accordance with some further embodiments, a hydroxyl terminated aliphatic polyester, in a first step undergoes a condensation reaction with N-benzyloxycarbonyl amino acid, followed by catalytic hydrogenation, in a second step, which results in the formation of a primary amine functional aliphatic polyester intermediate, such as described in Bioconjugate Chemistry, 2002, 13 (5), pp 1159-1162. In a third step, at least some of the primary amines of the primary amine functional aliphatic polyester intermediate are reacted with one or more ketones, which results in the formation of an aliphatic polyester having imine groups and optionally primary amine groups. The aliphatic polyester having at least two reactive groups, with some embodiments, has an Mn of from 210 g/mole to 20,000 g/mole, or from 250 g/mole to 15,000 g/mole, or from 250 g/mole to 10,000 g/mole.

The aliphatic polycarbonate having at least two reactive groups includes a plurality of carbonate linkages (—O—C(O)—O—), and is free of aromatic groups. With some embodiments, the aliphatic polycarbonate includes a linear or branched C₂-C₂₀ alkyl linkage and/or a C₃-C₁₀ cycloalkyl linkage, independently between and/or extending from each carbonate linkage. The aliphatic polycarbonate having at least two reactive groups can be prepared in accordance with art recognized methods. With some embodiments, a hydroxyl functional polycarbonate having at least two hydroxyl groups is reacted with an aziridine, which results in the formation of an amine functional polycarbonate intermediate having at least two primary amine groups. At least some of the primary amines of the amine functional polycarbonate intermediate can next be reacted with one or more ketones, which results in the formation of a polycarbonate having imine groups and optionally primary amine groups. With some further embodiments, the aliphatic polycarbonate having at least two reactive groups is prepared in a first step by ring-opening of trimethylene carbonate in the presence of a nitrophenyl functionalized initiator, followed by, in a second step, a reduction reaction resulting in the formation of primary amines, such as described in Macromolecules, 1997, 30, 6074. In a third step, at least some of the primary amine groups of the primary amine functional aliphatic polycarbonate intermediate are reacted with one or more ketones, which results in the formation of an aliphatic polycarbonate having imine groups and optionally primary amine groups. The aliphatic polycarbonate having at least two reactive groups, with some embodiments, has an Mn of from 275 g/mole to 20,000 g/mole, or from 300 g/mole to 15,000 g/mole, or from 300 g/mole to 10,000 g/mole.

The aliphatic polyurethane polycarbonate having at least two reactive groups includes a plurality of urethane linkages (—O—C(O)—N(H)—), and is free of aromatic groups. With some embodiments, the aliphatic polyurethane includes a linear or branched C₁-C₂₀ alkyl linkage and/or a C₃-C₁₀ cycloalkyl linkage, independently between and/or extending from each carbonate linkage. The aliphatic polyurethane having at least two reactive groups can be prepared in accordance with art recognized methods. With some embodiments, a hydroxyl functional polyurethane having at least two hydroxyl groups is reacted with an aziridine, which results in the formation of an amine functional polyurethane intermediate having at least two primary amine groups. At least some of the primary amines of the amine functional polyurethane intermediate can next be reacted with one or more ketones, which results in the formation of a polyurethane having imine groups and optionally primary amine groups. The aliphatic polyurethane having at least two reactive groups, with some embodiments, has an Mn of from 350 g/mole to 20,000 g/mole, or from 400 g/mole to 15,000 g/mole, or from 400 g/mole to 10,000 g/mole.

The aliphatic polyethylenimine having at least two reactive groups is free of aromatic groups. The aliphatic polyethylenimine, can be referred to herein as a polyethylenimine having at least two reactive groups. With some embodiments, the aliphatic polyethylenimine, in a first step, is prepared by ring-opening polymerization of aziridine. The resulting polyethylenimine intermediate, with some embodiments, is branched and includes a combination of primary amine groups, secondary amine groups, and tertiary amine groups. At least some of the primary amines of the polyethylenimine intermediate are reacted with one or more ketones, which results in the formation of an aliphatic polyethylenimine having imine groups and optionally primary amine groups. With some embodiments, a commercially available polyethylenimine having primary amine groups (such as an EPOMIN polyethylenimine) is reacted with one or more ketones, which results in the formation of an aliphatic polyethylenimine having imine groups and optionally primary amine groups. The aliphatic polyethylenimine having at least two reactive groups, with some embodiments, has an Mn of from 140 g/mole to 5000 g/mole, or from 150 g/mole to 2500 g/mole, or from 200 g/mole to 2500 g/mole.

The reactive component, with some embodiments, has a reactive group equivalent weight of from 70 g/mole to 2600 g/mole, or from 75 g/mole to 2000 g/mole, or from 80 g/mole to 1500 g/mole. The recited reactive group equivalent weight values, and related ranges, in each case represent a combination (or sum) of primary amine group equivalent weight and imine group equivalent weight.

With some embodiments, the reactive component is formed from the reaction of a polyamine that includes at least two primary amine groups (—NH₂), and at least one ketone (type of ketone). The reaction between a primary amine and a ketone results in the formation an imine group, such as represented by Formula (B) above. Each ketone that is reacted with a primary amine of the polyamine, with some embodiments, has a formula weight of less than 300 g/mole (such as from 58 g/mole to less than 300 g/mole). Examples of such ketones include, but are not limited to, dimethyl ketone, methyl ethyl ketone, diethyl ketone, methyl isobutyl ketone, methyl n-propyl ketone, methyl isopropyl ketone, cyclopentanone, and acetophenone. With some further embodiments, at least 80 percent of the primary amine groups, or at least 85 percent of the primary amine groups, or at least 90 percent of the primary amine groups, or at least 95 percent of the primary amine groups, or 100 percent of the primary amine groups (including ranges thereof, such as from 80 to 100%, or from 85% to 100%, or from 90% to 100%, or from 95% to 100% of primary amine groups), of the polyamine are reacted with ketone and thereby converted to imine groups.

With some embodiments, the reactive component includes: from 0% to 20% primary amine groups, and from 80% to 100% imine groups; or from 0% to 15% primary amine groups, and from 85% to 100% imine groups; or from 0% to 10% primary amine groups, and from 90% to 100% imine groups; or from 0% to 5% primary amine groups, and from 95% to 100% imine groups, the percentages in each case based on the total number of primary amine groups and imine groups.

The reactive component, with some embodiments, is present in the curable photochromic composition in an amount of from 1 percent by weight to 20 percent by weight, or from 1 percent by weight to 15 percent by weight, or from 2 to 14 percent by weight, the percent weights in each case being based on total resin solids weight.

The curable photochromic composition of the present invention includes a non-reactive component that is free of functional groups that are reactive with: the polyisocyanate; and the reactive component. More particularly, the non-reactive component is free of functional groups that are reactive with: the isocyanate groups of the polyisocyanate; and the reactive groups (primary amine groups and imine groups) of the reactive component.

The non-reactive component, with some embodiments, includes at least one of polyethers, polyesters, polycarbonates, polyurethanes, and/or organo phosphates. In further accordance with the present invention, the non-reactive component includes at least one of aliphatic polyethers, aliphatic polyesters, aliphatic polycarbonates, aliphatic polyurethanes, and/or organo phosphates. In accordance with some embodiments, the polyethers, polyesters, polycarbonates, and polyurethanes from which the non-reactive component can be selected, each independently have an Mn of 300 to 10,000 g/mole, or from 300 to 8000 g/mole, or from 300 to 7000 g/mole.

The polyethers of the non-reactive component include a plurality of ether linkages (—O—), and are free of aromatic groups in the case of aliphatic polyethers. With some embodiments, the polyether is an aliphatic polyether and includes a linear or branched C₂-C₂₀ alkyl linkage and/or a C₃-C₁₀ cycloalkyl linkage, independently between and/or extending from each ether linkage. The polyethers of the non-reactive component can be prepared in accordance with art recognized methods. The polyether of the non-reactive component, with some embodiments has terminal ether groups, such as terminal —OR^{a} groups, where R^{a} in each case is independently a linear or branched C₁-C₂₀ alkyl group or a C₃-C₁₀ cycloalkyl group. With some additional embodiments, the polyether of the non-reactive component has terminal carboxylic acid ester groups, such as terminal —OC(O) R^{a} groups, where R^{a} in each case is independently a linear or branched C₁-C₂₀ alkyl group or a C₃-C₁₀ cycloalkyl group.

The polyesters of the non-reactive component include a plurality of carboxylic acid ester linkages (—C(O)—O—), and are free of aromatic groups in the case of aliphatic polyesters. With some embodiments, the polyester of the non-reactive component is an aliphatic polyester and includes a linear or branched C₂-C₂₀ alkyl linkage and/or a C₃-C₁₀ cycloalkyl linkage, independently between and/or extending from each carboxylic acid ester linkage linkage. The polyesters of the non-reactive component can be prepared in accordance with art recognized methods. With some additional embodiments, the polyester of the non-reactive component has terminal carboxylic acid ester groups, such as terminal —OC(O)R^{a} groups and/or terminal —C(O)OR^{a} groups, where R^{a} in each case is independently a linear or branched C₁-C₂₀ alkyl group or a C₃-C₁₀ cycloalkyl group.

The polycarbonates of the non-reactive component include a plurality of carbonate linkages (—O—C(O)—O—), and are free of aromatic groups in the case of aliphatic polycarbonates. With some embodiments, the polycarbonate of the non-reactive component is an aliphatic polycarbonate and includes a linear or branched C₂-C₂₀ alkyl linkage and/or a C₃-C₁₀ cycloalkyl linkage, independently between and/or extending from each carbonate linkage. The polycarbonates of the non-reactive component can be prepared in accordance with art recognized methods. With some additional embodiments, the polycarbonate of the non-reactive component has terminal carbonate groups, such as terminal —O—C(O)—O—R^{a} groups, where R^{a} in each case is independently a linear or branched C₁-C₂₀ alkyl group or a C₃-C₁₀ cycloalkyl group.

The polyurethanes of the non-reactive component include a plurality of urethane linkages (—O—C(O)—N(H)—), and are free of aromatic groups in the case of aliphatic polyurethanes. With some embodiments, the polyurethane of the non-reactive component is an aliphatic polyurethane and includes a linear or branched C₂-C₂₀ alkyl linkage and/or a C₃-C₁₀ cycloalkyl linkage, independently between and/or extending from each urethane linkage. The polyurethanes of the non-reactive component can be prepared in accordance with art recognized methods. With some additional embodiments, the polyurethane of the non-reactive component has terminal urethane groups, such as terminal —N(H)—C(O)—OR^{a} groups, where R^{a} in each case is independently a linear or branched C₅-C₂₀ alkyl group or a C₆-C₁₀ cycloalkyl group.

The organo phosphates from which the non-reactive component can be selected, with some embodiments, are represented by the following Formula (C),

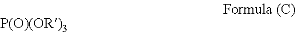

With reference to Formula (C), each R′ is in each case independently selected from alkyl, haloalkyl, perhaloalkyl, cycloalkyl, heterocycloalkyl, aryl, heteroaryl, and combinations thereof (including those classes and examples thereof as recited previously herein). With some further embodiments, each R′ of Formula (C) is in each case independently selected from alkyl, cycloalkyl, aryl, and combinations thereof. With further reference to Formula (C), and in accordance with some further embodiments, each R′ is in each case independently selected from C₁-C₂₀ linear alkyl, C₃-C₂₀ branched alkyl, C₃-C₂₀ cycloalkyl, C₅-C₂₀ aryl, and combinations thereof. With additional reference to Formula (C), and in accordance with some additional embodiments, each R′ is in each case independently selected from: phenyl; phenyl substituted with at least one of C₁-C₂₀ linear alkyl, C₃-C₂₀ branched alkyl, or C₃-C₂₀ cycloalkyl; C₁-C₂₀ linear alkyl substituted with at least one phenyl; C₃-C₂₀ branched alkyl substituted with at least one phenyl; and C₃-C₂₀ cycloalkyl substituted with at least one phenyl. Non-limiting examples of organo phosphates, from which the non-reactive component can be selected include, tricresyl phosphate, tris(2-phenylethyl)phosphate, tris(2-chloroethyl)phosphate, tris(1,3-dichloro-2-propyl)phosphate, cresyl diphenyl phosphate, tris(2,3-dibromopropyl)phosphate, tris-(2-ethylhexyl)phosphate, and tris(2-methylphenyl)phosphate.

The non-reactive component of the curable photochromic compositions of the present invention, with some embodiments, has a viscosity (at 25° C.) of from 1 cP to 60,000 cP, or from 1 cP to 10,000 cP, or from 1 cP to 7500 cP (where cP in each case means centipoise). Viscosity can be measured in accordance with art-recognized methods. With some embodiments, viscosity is measured using a rotation viscometer such as a Brookfield CAP 2000+ viscometer, available from AMETEK, Inc., according to the manufacturer's instructions. Additional methods of measuring viscosity include, but are not limited to, those as described in ASTM D789, or ASTM D4878.

In accordance with some embodiments of the curable photochromic compositions of the present invention, the non-reactive component is present in an amount of from 10 percent by weight to 40 percent by weight, or from 15 percent by weight to 35 percent by weight, or from 20 percent by weight to 35 percent by weight, where the percent weights are in each case based on total resin solids of the curable photochromic composition.

The curable photochromic compositions of the present invention include a photochromic compound(s). The photochromic compound can be selected from known classes and examples of photochromic compounds, and can include combinations or mixtures thereof.

For example, although not limiting herein, mixtures of photochromic compounds can be used to attain certain activated colors, such as a near neutral gray or near neutral brown. See, for example, U.S. Pat. No. 5,645,767, col. 12, line 66 to col. 13, line 19, which describes the parameters that define neutral gray and brown colors, which disclosure is specifically incorporated by reference herein.

With some embodiments, the photochromic compound, of the curable photochromic compositions of the present invention, is selected from the group consisting of naphthopyrans, benzopyrans, phenanthropyrans, indenonaphthopyrans, spiro(indoline) naphthoxazines, spiro(indoline)pyridobenzoxazines, spiro(benzindoline)pyridobenzoxazines, spiro(benzindoline) naphthoxazines, spiro(indoline)-benzoxazines, fulgides, fulgimides, diarylethenes, and mixtures of such photochromic compounds.

Further examples of other photochromic compounds that can be used in curable photochromic compositions of the present invention include, but are not limited to, those disclosed at column 34, line 20 through column 35, line 13 of U.S. Pat. No. 9,028,728 B2, which disclosure is specifically incorporated by reference herein.

The photochromic compound is present in the curable photochromic compositions of the present invention in an amount at least sufficient so as to provide an article prepared from the composition with a desirable level of photochromic properties, which in some embodiments is referred to as a photochromic amount. With some embodiments, the amount of photochromic compound(s) present in the curable photochromic composition is from 0.001 percent by weight to 40 percent by weight, or from 0.001 to 10 percent by weight, or from 0.01 to 8 percent by weight, or from 0.1 to 2.5 percent by weight, where the percent by weights are in each case based on the total resin solids weight.

The curable photochromic compositions of the present invention can, with some embodiments, optionally include additives such as, but not limited to: waxes, such as for flow and wetting; flow control agents, such as poly(2-ethylhexyl) acrylate; antioxidants; adhesion promoters, such as (3-glycidoxypropyl) trimethoxysilane; surfactants; and ultraviolet (UV) light absorbers. Examples of useful antioxidants and UV light absorbers include, but are not limited to, those available commercially from BASF under the trademarks IRGANOX and TINUVIN. A non-limiting class of antioxidants are hindered amine light stabilizers (HALS), which can include one or more 2,2,6,6-tetralkylpiperindin-4-yl groups, such as one or more 2,2,6,6-tetramethylpiperidin-4-yl groups. These optional additives, when used, can be present in amounts up to 20 percent by weight, based on total resin solids weight.

The curable photochromic compositions of the present invention can, with some embodiments, further include one or more fixed-tint dyes. As used herein, the term “fixed-tint dye” and related terms, such as “fixed-colorant,” “static colorant,” “fixed dye,” and “static dye” means dyes that are: non-photosensitive materials, which do not physically or chemically respond to electromagnetic radiation with regard to the visually observed color thereof. The term “fixed-tint dye” and related terms as used herein does not include and is distinguishable from photochromic compound. As used herein, the term “non-photosensitive materials” means materials that do not physically or chemically respond to electromagnetic radiation with regard to the visually observed color thereof, including, but not limited to, fixed-tint dyes.

One or more fixed-tint dyes can be present in the curable photochromic compositions of the present invention for purposes including, but not limited to, providing a cured article prepared from the curable photochromic compositions with: at least a base (or first) color characteristic of the fixed-tint dye, when the photochromic compound is not activated; and optionally a second color characteristic of the combination of the fixed-tint dye and the photochromic compound when activated, such as by exposure to actinic radiation.

The optional fixed-tint dye of the curable photochromic composition, with some embodiments, includes at least one of azo dyes, anthraquinone dyes, xanthene dyes, azime dyes, iodine, iodide salts, polyazo dyes, stilbene dyes, pyrazolone dyes, triphenylmethane dyes, quinoline dyes, oxazine dyes, thiazine dyes, and polyene dyes.

The fixed-tint dye can be present in the curable photochromic composition in varying amounts to provide the intended effect in the cured article prepared therefrom. With some embodiments, the fixed-tint dye is present in the curable photochromic composition in an amount of from 0.001 to 15 percent by weight, or from 0.01 to 10 percent by weight, or from 0.1 to 2.5 percent by weight, the percent weights in each case being based on the total resin solids weight of the curable photochromic composition.

The curable photochromic compositions of the present can, with some embodiments, include one or more solvents, such as one or more organic solvents.

Classes of organic solvents that can be present in the curable photochromic compositions of the present invention include, but are not limited to: ketones, such as, acetone, methyl ethyl ketone, and methyl isobutyl ketone; ethers, such as, dimethyl ether and methyl ethyl ether; cyclic ethers, such as, tetrahydrofuran and dioxane; esters, such as, ethyl acetate, ethyl lactate, ethylene carbonate and propylene carbonate; nitrogen containing cyclic compounds, such as, pyrrolidone, N-methyl-2-pyrrolidone, 1-butyl-pyrrolidinone, and 1,3-dimethyl-2-imidazolidinone; sulfur containing compounds, such as, dimethyl sulfoxide and tetramethylene sulfone; aromatic compounds, such as, toluene, xylene, anisole, and butyl benzoate; and mixtures of aromatic compounds, such as, but not limited to, Aromatic 100 Fluid, which is a commercially available mixture of C₉-C₁₀ dialkyl- and trialkyl-benzenes, and Aromatic 150 Fluid, which is a commercially available mixture of C₁₀-C₁₂ alkylbenzenes and alkylnaphthalenes.

Solvent(s) can be present in the curable photochromic compositions of the present invention, in an amount of from 5 to 95 percent by weight, or from 15 to 80 percent by weight, from 30 to 70 percent by weight, or from 30 to 60 percent by weight, in each case based on the total weight of the curable photochromic composition (including the weight of the solvent).

The curable photochromic compositions of the present can, with some embodiments, include one or more cure catalysts for catalyzing the reaction between the unblocked and/or blocked isocyanate groups of the polyisocyanate component and the reactive groups of the reactive component. Classes of useful catalysts include, but are not limited to: metal compounds, such as, but not limited to, organic tin compounds, organic bismuth compounds, organic zinc compounds, organic zirconium compounds, organic aluminum compounds, organic nickel compounds, organic mercury compounds, and alkali metal compounds; and amine compounds, such as tertiary amine compounds, and quaternary ammonium compounds. Examples of organic tin compounds include, but are not limited to: tin(II) salts of carboxylic acids, such as, tin(II) acetate, tin(II) octanoate, tin(II) ethylhexanoate and tin(II) laurate; tin(IV) compounds, such as, dibutyltin oxide, dibutyltin dichloride, dibutyltin diacetate, dibutyltin dilaurate, dibutyltin maleate and dioctyltin diacetate. Examples of suitable tertiary amine catalysts include, but are not limited to, diazabicyclo[2.2.2]octane and 1,5-diazabicyclo[4,3,0]non-5-ene. Examples of organic bismuth compounds include, but are not limited to, bismuth carboxylates. Examples of alkali metal compounds include, but are not limited to, alkali metal carboxylates, such as, but not limited to, potassium acetate, and potassium 2-ethylhexanoate. Examples of quaternary ammonium compounds include, but are not limited to, N-hydroxyalkyl quaternary ammonium carboxylates. With some embodiments, the catalyst is selected from tin(II) octanoate, dibutyltin(IV) dilaurate, and/or bismuth 2-ethylhexanoate.

With some embodiments of the present invention, the curable photochromic composition includes a cure catalyst that includes an organic tin compound selected from tin(II) salts of carboxylic acids, tin(IV) compounds, or combinations thereof.

With some further embodiments of the present invention, the curable photochromic composition includes an organic tin compound that is selected from tin(II) acetate, tin(II) octanoate, tin(II) ethylhexanoate, tin(II) laurate, dibutyltin oxide, dibutyltin dichloride, dibutyltin diacetate, dibutyltin dilaurate, dibutyltin maleate, dioctyltin diacetate, or combinations thereof.

The cure catalyst is typically present in an amount of about 0.05 to about 5.0 percent by weight, or about 0.25 to about 2.0 percent by weight, based on the total weight of resin solids of the curable photochromic composition.

The curable photochromic composition of the present invention can be cured by any suitable methods that result in the formation of covalent bonds between isocyanate groups of the polyisocyanate and reactive groups (primary amine groups and imine groups) of the reactive component. With some embodiments, the curable photochromic composition is cured by exposure to elevated temperature (in excess of ambient room temperature, such as above 25° C.). Exposure to elevated temperatures, with some embodiments, results in deblocking of blocked isocyanate groups of the polyisocyanate (when it includes blocked isocyanate groups). As used herein, by “cured” is meant a three dimensional crosslink network is formed by covalent bond formation, resulting from reaction between isocyanate groups of the polyisocyanate and reactive groups (primary amine groups and imine groups) of the reactive component. When cured at elevated temperature, the curable photochromic composition can be referred to herein as a thermosetting curable photochromic composition. The temperature at which the thermosetting curable photochromic composition of the present invention is cured is variable and depends in part on the amount of time during which curing is conducted. With some embodiments, the curable photochromic composition is cured at an elevated temperature of from 80° C. to 175° C., or from 85° C. to 150° C., or from 90° C. to 130° C., for a period of 15 to 240 minutes.

The present invention also relates to articles, and in particular, photochromic articles that are prepared from the curable photochromic composition of the present invention as described previously herein. With some embodiments, the photochromic article is selected from layers (including films and/or sheets), and 3-dimensional articles.

Classes of 3-dimensional articles, that can be prepared from the curable photochromic compositions of the present invention, include, but are not limited to, ophthalmic articles, display articles, windows, and mirrors.

More typically, the curable photochromic compositions of the present invention are used to prepare photochromic layers, such as photochromic films and photochromic sheets. As used herein, the term “film” means a layer that is not self-supporting, such as, but not limited to, a coating. As used herein, the term “sheet” means a layer that is self-supporting, such as, but not limited to, an extruded sheet.

The present invention also relates to an article, such as a photochromic article, that comprises: (A) a substrate; and (B) a photochromic layer over at least one surface of the substrate, wherein the photochromic layer is formed from the curable photochromic composition of the present invention.

The article, that includes a substrate, and a photochromic layer over at least one surface of the substrate (formed from the curable photochromic composition of the present invention) can, with some embodiments, be selected from ophthalmic articles, display articles, windows, and mirrors. Correspondingly, the substrate of the article can be selected from ophthalmic substrates, displays, windows, and mirrors. The substrate can be composed of one or more suitable materials, including, but not limited to: organic materials, such as organic polymeric materials, such as, but not limited to, thermoplastic polycarbonates, crosslinked polycarbonates, poly(meth)acrylates, and combinations thereof; glasses, such as silica-based glasses; metals; ceramic materials; and combinations thereof. Examples of substrates that can be included in the article (including optical elements) of the present invention include, but are not limited to, those described at column 35, line 5 through column 36, line 57 of U.S. Pat. No. 8,628,685 B2, which disclosure is incorporated herein by reference.

The substrate, with some embodiments, can optionally include a photochromic material and/or a fixed-tint dye, which can each be selected from those classes and examples of photochromic materials and fixed-tint dyes as described previously herein. The optional photochromic material(s)/compound(s) present in the substrate can be the same or different than the photochromic compound(s) of the photochromic layer. The optional fixed-tint dye(s) can be the same or different than the optional fixed-tint dye(s) of the photochromic layer.

The photochromic layer of the article can be a photochromic film or a photochromic sheet. With some embodiments, the photochromic film of the article is a photochromic coating, and the curable photochromic composition of the present invention is a curable photochromic coating composition.

The curable photochromic coating composition can be applied to the substrate in accordance with art-recognized methods, which include, but are not limited to, spray application methods, curtain coating application methods, draw-down blade (or bar) application methods, dip-coating application methods, spin-coating application methods, jet printing methods (such as inkjet printing methods, where the “ink” is replaced with a curable photochromic composition according to the present invention), and combinations thereof.

After application of the curable photochromic composition over at least one surface of the substrate, the applied curable photochromic composition is cured, such as described previously herein. The photochromic layer can be in the form of a single layer or multiple layers. When in the form of multiple layers, each layer of the photochromic layer can be prepared from curable photochromic compositions according to the present invention, having the same or different compositions, such as the same or different photochromic compound(s). The photochromic layer can have any suitable thickness, such as from 10 micrometers to 250 micrometers, or from 15 micrometers to 75 micrometers.

In addition to the photochromic layer, the article can optionally include one or more further art-recognized layers, such as, but not limited to: a primer layer(s); an adhesive layer(s); a protective layer(s) (such as a hard-coat layer); a polarizing layer(s); a birefringent layer(s); an antireflective layer(s); and/or another photochromic layer(s) that is prepared from a composition other than the curable photochromic composition of the present invention.

The present invention further relates to a photochromic multilayer article including at least one photochromic layer formed from the curable photochromic composition of the present invention. Each layer of the photochromic multilayer article can independently be in the form of a film or a sheet. The photochromic multilayer article can include, with some embodiments, two or more layers that are formed from the same or different curable photochromic compositions of the present invention.

The multilayer article of the present invention can optionally include one or more further art-recognized layers, such as, but not limited to: an adhesive layer(s); a protective layer(s) (such as a hard-coat layer); a polarizing layer(s); a birefringent layer(s); an antireflective layer(s); and/or another photochromic layer(s) that is prepared from a composition other than the curable photochromic composition of the present invention.

The multilayer article of the present invention can have any suitable thickness, such as from 10 micrometers to 1000 micrometers, or from 15 micrometers to 750 micrometers, or from 25 to 100 micrometers.

The multilayer article of the present invention can be used alone or in conjunction with another article, such as a substrate. The substrate can be selected from those classes and examples of substrates as described previously herein with regard to the article of the present invention, such as ophthalmic substrates, displays, windows, and/or mirrors. The substrate can be composed of one or more suitable materials, including, but not limited to: organic materials, such as organic polymeric materials; glasses, such as silica-based glasses; metals; ceramic materials; and combinations thereof.

The multilayer article of the present invention can be adhered to a surface of a substrate by art-recognized methods, such as, but not limited to: static clinging, such as with static electricity; one or more interposed adhesive layers; fusion bonding, such as thermal fusion bonding; and in-mold formation, such as where the multilayer article is placed in a mold, and the substrate is formed against at least one surface of the multilayer article within the mold. The multilayer article of the present invention can, with some embodiments, be supported by one or more brackets that engage retainingly with one or more peripheral regions of the multilayer article.

The present invention can be further characterized by one or more of the following non-limiting clauses.

Clause 1: A curable photochromic composition comprising:
(a) a photochromic compound;
(b) a polyisocyanate comprising at least two isocyanate groups;
(c) a reactive component comprising at least two reactive groups that are each reactive with isocyanate groups of the polyisocyanate, wherein each reactive group of the reactive component is independently selected from primary amine and imine, provided that at least one reactive group of the reactive component is selected from imine; and
(d) a non-reactive component that is free of functional groups that are reactive with the polyisocyanate and the reactive component.

Clause 2: The curable photochromic composition of clause 1, wherein a molar ratio of moles of isocyanate groups of the polyisocyanate to total moles of reactive groups of the reactive component is from 1:1 to 20:1, or from 1:1 to 18:1, or from 1:1 to 17:1, or from 1:1 to 16.5:1.

Clause 3: The curable photochromic composition of clause 1 or clause 2, wherein the polyisocyanate comprises at least one of, linear or branched aliphatic polyisocyanates, cycloaliphatic polyisocyanates, biurets thereof, allophanates thereof, isocyanurates thereof, and combinations thereof.

Clause 4: The curable photochromic composition of any one of clauses 1-3, wherein the polyisocyanate has an isocyanate equivalent weight of from 95 to 500 g/mole, or from 150 to 400 g/mole, or from 150 to 350 g/mole.

Clause 5: The curable photochromic composition of any one of clauses 1-4, wherein at least some isocyanate groups of the polyisocyanate are reversibly blocked with a blocking agent.

Clause 6: The curable photochromic composition of any one of clauses 1-5, wherein said polyisocyanate is present in an amount of from 40 percent by weight to 90 percent by weight, or from 45 percent by weight to 90 percent by weight, or from 50 percent by weight to 85 percent by weight, the percent weights in each case being based on total resin solids weight.

Clause 7: The curable photochromic composition of any one of clauses 1-6, wherein the reactive component comprises at least one of aliphatic polyether, aliphatic polyester, aliphatic polycarbonate, aliphatic polyethylenimine, or aliphatic polyurethane, each independently having at least two reactive groups.

Clause 8: The curable photochromic composition of any one of clauses 1-7, wherein the reactive component has a reactive group equivalent weight of from 70 g/mole to 2600 g/mole, or from 75 g/mole to 2000 g/mole, or from 80 g/mole to 1500 g/mole.

Clause 9: The curable photochromic composition of any one of clauses 1-8, wherein the reactive component is formed from the reaction of a polyamine comprising primary amine groups, and at least one ketone,

Clause 10: The curable photochromic composition of clause 9, wherein each ketone independently has a formula weight of less than 300 g/mole.

Clause 11: The curable photochromic composition of clause 9 or clause 10, wherein each ketone independently has a formula weight of from 58 g/mole to less than 300 g/mole.

Clause 12: The curable photochromic composition of any one of clauses 9-11, wherein at least 80 percent of primary amine groups of the polyamine, or at least 85 percent of primary amine groups of the polyamine, or at least 90 percent of primary amine groups of the polyamine, or at least 95 percent of primary amine groups of the polyamine, or 100 percent of primary amine groups of the polyamine, are converted to imine groups by reaction with ketone.

Clause 13: The curable photochromic composition of any one clauses 1-12, wherein the reactive component is present in an amount of from 1 percent by weight to 20 percent by weight, or from 1 percent by weight to 15 percent by weight, or from 2 to 14 percent by weight, the percent weights in each case being based on total resin solids weight of the curable photochromic composition.

Clause 14: The curable photochromic composition of any one of clauses 1-13, wherein the non-reactive component has a viscosity of from 1 cP to 60,000 cP, or from 1 cP to 10,000 cP, or from 1 cP to 7500 cP, in each case at 25° C.

Clause 15: The curable photochromic composition of any one of clauses 1-14, wherein the non-reactive component comprises at least one of polyethers, polyesters, polycarbonates, polyurethanes, and/or organo phosphates.

Clause 16: The curable photochromic composition of any one of clauses 1-15, wherein the non-reactive component comprises at least one of polyethers, polyesters, polycarbonates, and/or polyurethanes, which in each case independently have an Mn of 300 to 10,000 g/mole, or from 300 to 8000 g/mole, or from 300 to 7000 g/mole.

Clause 17: The curable photochromic composition of any one of clauses 1-16, wherein the non-reactive component comprises at least one of aliphatic polyethers, aliphatic polyesters, aliphatic polycarbonates, and/or aliphatic polyurethanes, which in each case independently have an Mn of 300 to 10,000 g/mole, or from 300 to 8000 g/mole, or from 300 to 7000 g/mole.

Clause 18: The curable photochromic composition of any one of clauses 1-17, wherein the non-reactive component comprises an organo phosphate represented by the following Formula (C),

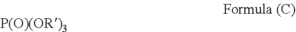

wherein R′ in each case is independently selected from alkyl, haloalkyl, perhaloalkyl, cycloalkyl, heterocycloalkyl, aryl, heteroaryl, and combinations thereof.

Clause 19: The curable photochromic composition of clause 18, wherein R′ in each case is independently selected from: phenyl; phenyl substituted with at least one of C₁-C₂₀ linear alkyl, and/or C₃-C₂₀ branched alkyl; C₁-C₂₀ linear alkyl substituted with at least one phenyl; and C₃-C₂₀ branched alkyl substituted with at least one phenyl.

Clause 20: The curable photochromic composition of any one of clauses 1-19, wherein the non-reactive component is present in an amount of from 10 percent by weight to 40 percent by weight, or from 15 percent by weight to 35 percent by weight, or from 20 percent by weight to 35 percent by weight, the percent weights in each case being based on total resin solids of the curable photochromic composition.

Clause 21: The curable photochromic composition of any one of clauses 1-20, wherein the photochromic compound (a) comprises at least one of of naphthopyrans, benzopyrans, phenanthropyrans, indenonaphthopyrans, spiro(indoline)naphthoxazines, spiro(indoline)pyridobenzoxazines, spiro(benzindoline)pyridobenzoxazines, spiro(benzindoline) naphthoxazines, spiro(indoline)-benzoxazines, fulgides, fulgimides, and/or diarylethenes.

Clause 22: The curable photochromic composition of any one of clauses 1-21, wherein the curable photochromic composition further comprises an additive selected from waxes, flow control agents, antioxidants, surfactants, adhesion promoters, ultraviolet light absorbers, and combinations thereof.

Clause 23: The curable photochromic composition of any one of clauses 1-22, wherein the curable photochromic composition further comprises a cure catalyst selected from metal compounds, amine compounds, and combinations thereof.

Clause 24: An article comprising:
(A) a substrate; and
(B) a photochromic layer over at least one surface of the substrate, wherein the photochromic layer is formed from the curable photochromic composition of any one of clauses 1-23.

The present invention is more particularly described in the following examples, which are intended to be illustrative only, since numerous modifications and variations therein will be apparent to those skilled in the art. Unless otherwise specified, all parts and all percentages are by weight.

### EXAMPLES

In Part 1 of the following examples there is described the preparation of a polyethylenimine having primary amine groups and imine groups (Example 1). In Part 2 the preparation of comparative curable photochromic compositions (CE-2, CE-3, and CE-4) are described. In Part 3 the preparation of curable photochromic compositions according to the present invention (Examples 5-12) are described. In Part 3 there is described the preparation of photochromic test specimens. In Part 4 physical testing and evaluation of the test specimens, prepared using the comparative and inventive curable photochromic compositions, are described and summarized.

### Part 1. Preparation of Polyethylenimine Having Primary Amine Groups and Imine Groups.

### Example 1

EPOMIN™ SP006 polyethylenimine (10 g; a branched polyethylenimine with a reported number average molecular weight of 600 g/mole and a calculated primary amine equivalent weight of 142.8 g/mole, available from Nippon Shokubai Co., Ltd.) and methyl ethyl ketone (21.63 g) were combined in a closed 100 ml amber vial and stirred using a magnetic stir bar at 60° C. for 1 hour. From NMR analysis, the estimated conversion of primary amine to imine was determined to be approximately 82%, with a calculated equivalent weight of reactive groups (sum of primary amine groups and imine groups) of 178.5 g/mole. The resultant solution having a theoretical solids of 69 wt. % was used in the following compositions without any further purification or modification.

### Part 2. Preparation of Comparative Curable Photochromic Compositions.

### Comparative Examples CE-2 Through CE-4

Comparative Examples (CE) CE-2, CE-3, and CE-4 were prepared using the components listed in Table 1, shown in parts by weight. The components of Charge 1 were combined and heated to 70° C., stirred for a minimum of 1 hour until the solids were observed to have dissolved completely. Once cooled to room temperature, components of charge 2 were added and the solution was stirred for 1 hour. The components of Charge 3 were added and the solution was stirred for at least 1 hour prior to use.

TABLE 1
Comparative Examples

| | | CE-2 | CE-3 | CE-4 |
|---|---|---|---|---|
| Charge 1 | Photochromic dye blend⁽¹⁾ | 5.99 | 5.99 | 5.99 |
| | TINUVIN ® 144⁽²⁾ | 1.99 | 1.99 | 1.99 |
| | IRGANOX ® 245⁽³⁾ | 1.99 | 1.99 | 1.99 |
| | N-methyl pyrrolidinone | 51.20 | 51.20 | 51.20 |
| Charge 2 | (3-Glycidoxypropyl) | 4.48 | 4.48 | 4.48 |
| | trimethoxysilane | | | |
| | BYK ® 333⁽⁴⁾ | 0.08 | 0.08 | 0.08 |
| Charge 3 | TRIXENE ® BI-7960⁽⁵⁾ | 105.9 | 105.9 | 105.9 |
| | ETERNACOLL ® PH- | — | — | 22.8 |
| | 100D⁽⁶⁾ | | | |
| | Polyimine/amine of | — | 9.48 | 9.48 |
| | Example 1 | | | |
| | Triethylene glycol di-2- | 22.8 | — | — |
| | ethylhexanoate⁽⁷⁾ | | | |
| | Dibutyltin dilaurate | 0.26 | 0.26 | 0.26 |
| | NCO:reactive group ratio | — | 7:1 | 7:1 |

⁽¹⁾A blend of photochromic indenofused naphthopyran dyes formulated to provide a grey color on activation.
⁽²⁾A hindered amine light stabilizer, commercially available from BASF.
⁽³⁾An antioxidant commercially available from BASF.
⁽⁴⁾A polyether modified dimethylpolysiloxane copolymer, available from BYK-Chemie.
⁽⁵⁾A blocked hexamethylene diisocyanate biuret available from Baxenden Chemical Co. having an isocyanate equivalent weight (on solids) of 287 g/mole, provided at 70% solids in propylene glycol monomethyl ether.
⁽⁶⁾A polycarbonate diol with an average equivalent weight of 500 g/mole, commercially available from Ube Americas Inc.,
⁽⁷⁾Material has a reported viscosity of 15.8 cP at 20° C.

### Examples 5-7

Examples 5-7, which are curable photochromic compositions according to the present invention, were prepared using the components as listed in the following Table 2 (shown in parts by weight), and in accordance with the description provided above with regard to Comparative Examples 2-4. With the following Examples 5-7, the ratio of isocyanate to reactive groups (sum of primary amine groups and imine groups) was increased, with the level of non-reactive component being the same for Examples 5 and 6, and decreased for Example 7.

TABLE 2

| | | Example | Example | Example |
|---|---|---|---|---|
| | | 5 | 6 | 7 |
| Charge 1 | Photochromic dye | 6.00 | 6.04 | 6.00 |
| | blend⁽¹⁾ | | | |
| | TINUVIN ® 144⁽²⁾ | 2.00 | 2.00 | 2.00 |
| | IRGANOX ® 245⁽³⁾ | 2.00 | 2.00 | 2.00 |
| | N-methyl pyrrolidinone | 34.2 | 34.3 | 35.0 |
| Charge 2 | (3-Glycidoxypropyl) | 4.50 | 4.51 | 4.50 |
| | trimethoxysilane | | | |
| | BYK ® 333⁽⁴⁾ | 0.08 | 0.08 | 0.07 |
| Charge 3 | TRIXENE ® BI-7960⁽⁵⁾ | 91.3 | 105.2 | 112.3 |
| | Polyimine/amine of | 35.1 | 4.11 | 4.42 |
| | Example 1 | | | |
| | Triethylene glycol di-2- | 25 | 25 | 20 |
| | ethylhexanoate⁽⁷⁾ | | | |
| | Dibutyltin dilaurate | 0.28 | 0.28 | 0.30 |
| | NCO:reactive group | 1.6:1 | 15.2:1 | 16.3:1 |
| | ratio | | | |

### Examples 8-12

Examples 8-12, which are curable photochromic compositions according to the present invention, were prepared using the components as listed in the following Table 3 (shown in parts by weight), and in accordance with the description provided above with regard to Comparative Examples 2-4. With the following Examples 8-12, the ratio of isocyanate to reactive groups (sum of primary amine groups and imine groups) was in each case maintained at 5:1, while the amount and/or type of non-reactive component was varied.

TABLE 3

| | | Example | Example | Example | Example | Example |
|---|---|---|---|---|---|---|
| | | 8 | 9 | 10 | 11 | 12 |
| Charge 1 | Photochromic dye | 6.03 | 6.03 | 6.03 | 6.00 | 6.00 |
| | blend⁽¹⁾ | | | | | |
| | TINUVIN ® 144⁽²⁾ | 2.00 | 2.00 | 2.00 | 2.00 | 2.00 |
| | IRGANOX ® 245⁽³⁾ | 2.00 | 2.00 | 2.00 | 2.00 | 2.00 |
| | N-methyl pyrrolidinone | 35.0 | 34.2 | 48.19 | 36.22 | 36.2 |
| Charge 2 | (3-Glycidoxypropyl) | 4.50 | 4.50 | 4.50 | 4.50 | 4.50 |
| | trimethoxysilane | | | | | |
| | BYK ® 333⁽⁴⁾ | 0.07 | 0.07 | 0.08 | 0.07 | 0.08 |
| Charge 3 | TRIXENE ® BI-7960⁽⁵⁾ | 108.1 | 101.3 | 94.6 | 94.6 | 94.6 |
| | Polyimine/amine of | 13.9 | 13.0 | 12.0 | 12.0 | 12.0 |
| | Example 1 | | | | | |
| | Triethylene glycol di-2- | — | — | — | 15 | 30 |
| | ethylhexanoate⁽⁷⁾ | | | | | |
| | ADMEX( ™) 6187⁽⁸⁾ | 20 | 25 | 30 | 15 | — |
| | Dibutyltin dilaurate | 0.28 | 0.28 | 0.26 | 0.26 | 0.26 |
| | NCO:reactive group ratio | 5:1 | 5:1 | 5:1 | 5:1 | 5:1 |

⁽⁸⁾A commercially available polymeric adipate from Eastman Chemical Company, having a reported viscosity of 4800 cP to 6400 cP at 25° C., and a molecular weight (Mw) of 5860 g/mole as determined by GPC with polystyrene standard using THE as solvent.

### Part 3. Preparation of Photochromic Test Specimens.

The curable photochromic compositions of Comparative Examples 2-4, and Examples 5-12, were in each case separately applied by spin application to PDQ® coated Gentex® polycarbonate plano lenses, each having a diameter of 76 millimeters. Prior to spin application, each lens was corona treated using Tantec equipment with 70 KV and 1000 W settings. About 2 mL of each composition was dispensed onto the substrate, which was then rotated for six seconds at a spin speed sufficient to deposit: 0.28-0.35 g of wet coating onto the lens for each curable photochromic composition (wet weight depends on % non-volatile solids). The test specimens of CE-2, CE-3, CE-4, and Examples 5 through 12 were prepared in duplicate, then cured at 125° C. for 1 hour in a forced air electric oven.

### Part 4. Evaluation of Test Specimens.

Part 4a. Micro Hardness Evaluation.

One set of the duplicate set of test specimens were subjected to an additional thermal cure for three hours at 105° C. and set aside for micro-hardness measurements. These specimens were then subjected to micro-hardness testing using a Fischerscope HCV, Model H100SMC available from Fischer Technology, Inc. The hardness was measured at a penetration depth of 2 microns after a 100 mNewton load for 15 seconds. Each test specimen was measured at least twice and the resulting data was averaged. The micro hardness results are tabulated in Tables 4-6 further herein.

Pare 4b. Photochromic Performance.

The second set of the duplicate set of test specimens were further treated with corona as previously described and spin coated with a protective coating according to the formulation reported in Table 1 of Example 1 in U.S. Pat. No. 7,410,691 B2. The test specimens were cured in a UV oven equipped with D bulbs. Following this, each test specimen was thermally cured at 105° C. for three hours.

The photochromic performance of the test specimens was tested on a Bench for Measuring Photochromics (“BMP”) made by Essilor, Ltd. France. The BMP was maintained at a constant temperature of 73.4° F. (23° C.) during testing. Prior to testing, each of the coated test specimens were exposed to 365 nanometer ultraviolet light for about 10 minutes at a distance of about 14 centimeters to activate the photochromic materials. The UVA (315 to 380 nm) irradiance at the lens was measured with a LICOR® Model Li-1800 spectroradiometer, and found to be 22.2 watts per square meter. Each test specimen was then placed under a 500 watt, high intensity halogen lamp for about 10 minutes at a distance of about 36 centimeters to bleach (inactivate) the photochromic materials. The illuminance at the specimen was measured with the LICOR® spectroradiometer and found to be 21.9 Klux. Each test specimen was then kept in a dark environment at room temperature (from 70° F. to 75° F., or 21° C. to 24° C.) for at least one hour prior to testing on the BMP. Prior to measurement, each lens was measured for ultraviolet absorbance at 390 nanometers (Abs 390 nm).

The BMP optical bench was fitted with two 150-watt Newport Model #6255 Xenon arc lamps set at right angles to each other. The light path from Lamp 1 was directed through a 3 mm SCHOTT® KG-2 band-pass filter and appropriate neutral density filters that contributed to the required UV and partial visible light irradiance level. The light path from Lamp 2 was directed through a 3 mm SCHOTT® KG-2 band-pass filter, a SCHOTT® short band 400 nm cutoff filter and appropriate neutral density filters in order to provide supplemental visible light illuminance. A 2 inch×2 inch 50% polka dot beam splitter set at 45° to each lamp is used to mix the two beams. The combination of neutral density filters and voltage control of the Xenon arc lamp were used to adjust the intensity of the irradiance. Software i.e., BMPSoft version 2.1e was used on the BMP to control timing, irradiance, air cell and sample temperature, shuttering, filter selection, and response measurement. A ZEISS® spectrophotometer, Model MCS 601, with fiber optic cables for light delivery through the lens was used for response and color measurement. Photopic response measurements were collected on each lens.

The power output of the optical bench (i.e., the dosage of light that the lens was exposed to) was adjusted to 6.7 watts per square meter (W/m2) UVA, integrated from 315-380 nm, and 50 Klux illuminance, integrated from 380-780 nm. Measurement of this power set point was made using an irradiance probe and the calibrated Zeiss spectrophotometer. The lens sample cell was fitted with a quartz window and self-centering sample holder. The temperature in the sample cell was controlled at 23° C. through the software with a modified Facis, Model FX-10, environment simulator. Measurement of the sample's dynamic photochromic response and color measurements were made using the same Zeiss spectrophotometer with fiber optic cables for light delivery from a tungsten halogen lamp through the sample. The collimated monitoring light beam from the fiber optic cable was maintained perpendicular to the test sample while passing through the sample and directed into a receiving fiber optic cable assembly attached to the spectrophotometer. The exact point of placement of the sample in the sample cell was where the activating xenon arc beam and the monitoring light beam intersected to form two concentric circles of light. The angle of incidence of the xenon arc beam at the sample placement point was about 30° from perpendicular.

Response measurements, in terms of a change in optical density (ΔOD) from the unactivated or bleached state to the activated or colored state were determined by establishing the initial unactivated transmittance, opening the shutter from the Xenon lamp(s) and measuring the transmittance through activation at selected intervals of time. Change in optical density was determined according to the formula: ΔOD=log₁₀(% Tb/% Ta), where % Tb is the percent transmittance in the bleached state and % Ta is the percent transmittance in the activated state. Optical density measurements were based on photopic optical density.

The results of the micro-hardness and photochromic performance for CE-2, CE-3, CE-4, and Examples 5-12 are summarized in the following Tables 4 to 6. The ΔOD at saturation was measured after 15 minutes of activation and the Fade Half Life (“T1/2”) value is the time interval in seconds for the ΔOD of the activated form of the photochromic material in the coating to reach one half the fifteen-minute ΔOD at 73.4° F. (23° C.), after removal of the activating light source.

### Comparative Examples 2-4

The micro-hardness values and photochromic performance of CE-2, CE-3, and CE-4 are summarized in the following Table 4.

TABLE 4

| | Fischer | | T½ @ | |
|---|---|---|---|---|
| | micro-hardness | | Photopic | NCO:reactive |
| Example | (N/mm²) | ΔOD | (seconds) | group ratio |
| CE-2 | 83 | Not measured | | — |
| CE-3 | 148 | — | >500 | 7:1 |
| CE-4 | 64 | 0.91 | 222 | 7:1 |

The coating prepared from CE-2 cured as the result of self-reaction of isocyanate groups of the polyisocyanate alone, and was hazy and correspondingly not suitable for use as part of an optical element. The coating prepared from CE-3 cured as the result of reaction between the reactive groups of the polyimine/amine of Example 1 and the isocyanate groups of the polyisocyanate, and had desirable hardness, but very slow and undesirable fade half-life (T_{1/2}). The coating prepared from CE-4 cured as the result of reaction between hydroxyl groups of the polycarbonate diol (which can be characterized as a reactive soft material), the reactive groups of the polyimine/amine of Example 1, and the isocyanate groups of the polyisocyanate, and had adequate hardness but unacceptable photochromic performance properties.

### Examples 5-7

### Varying the (NCO):(Reactive Group) Ratio

The test results of Examples 5-7 are summarized in the following Table 5.

TABLE 5

| | Fischer | | T½ @ | |
|---|---|---|---|---|
| | micro-hardness | | Photopic | NCO:reactive |
| Example | (N/mm²) | ΔOD | (seconds) | group ratio |
| 5 | 52 | 0.88 | 45 | 1.6:1 |
| 6 | 85 | 0.77 | 45 | 15.2:1 |
| 7 | 100 | 0.82 | 52 | 16.3:1 |

The results summarized in Table 5 demonstrate that increasing the (NCO):(reactive group) ratio while maintaining the same amount of non-reactive component (Examples 5 and 6) results in increased hardness, and a desirable level of photochromic performance. Example 7, having a higher (NCO):(reactive group) ratio and lower amount of non-reactive component (as compared to Examples 5 and 6) had further improved hardness and a desirable level of photochromic performance.

### Examples 8-12

### Varying Non-Reactive Component Amounts and Types

The test results of Examples 8-12 are summarized in the following Table 6.

TABLE 6

| | Fischer | | T½ @ | |
|---|---|---|---|---|
| | micro-hardness | | Photopic | NCO:reactive |
| Example | (N/mm²) | ΔOD | (seconds) | group ratio |
| 8 | 77 | 0.88 | 54 | 5:1 |
| 9 | 63 | 0.92 | 52 | 5:1 |
| 10 | 59 | 0.89 | 50 | 5:1 |
| 11 | 60 | 0.89 | 49 | 5:1 |
| 12 | 86 | 0.76 | 52 | 5:1 |

The test results summarized in Table 6 demonstrate that maintaining the same (NCO):(reactive group) ratio while increasing the amount of non-reactive component (Examples 8-10) resulted in an acceptable decrease in hardness while maintaining an acceptable level of photochromic performance. The test results of Examples 10-12, as summarized in Table 6, demonstrate that maintaining the same (NCO):(reactive group) ratio while varying the type of non-reactive component resulted in an increase in hardness while maintaining an acceptable level of photochromic performance.

The present invention has been described with reference to specific details of particular embodiments thereof. It is not intended that such details be regarded as limitations upon the scope of the invention except insofar as to the extent that they are included in the accompanying claims.

What is claimed is:

1. A curable photochromic composition comprising:
(a) a photochromic compound;
(b) a polyisocyanate comprising at least two isocyanate groups;
(c) a reactive component comprising at least two reactive groups that are each reactive with isocyanate groups, wherein each reactive group of the reactive component is independently selected from primary amine and imine, provided that at least one reactive group of said reactive component is selected from imine; and
(d) a non-reactive component that is free of functional groups that are reactive with said polyisocyanate and said reactive component.

2. The curable photochromic composition of claim 1, wherein a molar ratio of moles of isocyanate groups of the polyisocyanate to total moles of reactive groups of the reactive component is from 1:1 to 20:1.

3. The curable photochromic composition of claim 1, wherein the polyisocyanate comprises at least one of, linear or branched aliphatic polyisocyanates, cycloaliphatic polyisocyanates, biurets thereof, allophanates thereof, isocyanurates thereof, and combinations thereof.

4. The curable photochromic composition of claim 1, wherein said polyisocyanate has an isocyanate equivalent weight of from 95 to 500 g/mole.

5. The curable photochromic composition of claim 1, wherein at least some isocyanate groups of said polyisocyanate are reversibly blocked with a blocking agent.

6. The curable photochromic composition of claim 1, wherein said polyisocyanate is present in an amount of from 40 percent by weight to 90 percent by weight, based on total resin solids weight.

7. The curable photochromic composition of claim 1, wherein said reactive component comprises at least one of aliphatic polyether, aliphatic polyester, aliphatic polycarbonate, aliphatic polyethylenimine, or aliphatic polyurethane, each independently having at least two reactive groups.

8. The curable photochromic composition of claim 1, wherein said reactive component has a reactive group equivalent weight of from 70 g/mole to 2600 g/mole.

9. The curable photochromic composition of claim 1, wherein said reactive component is formed from the reaction of a polyamine comprising primary amine groups, and at least one ketone, wherein each ketone independently has a formula weight of less than 300 g/mole, and wherein at least 80 percent of primary amine groups of said polyamine are converted to imine groups by reaction with ketone.

10. The curable photochromic composition of claim 1, wherein said reactive component is present in an amount of from 1 percent by weight to 20 percent by weight, based on total resin solids weight.

11. The curable photochromic composition of claim 1, wherein said non-reactive component has a viscosity of from 1 cP to 60,000 cP, at 25° C.

12. The curable photochromic composition of claim 11, wherein said non-reactive component comprises at least one of polyethers, polyesters, polycarbonates, polyurethanes, or organo phosphates.

13. The curable photochromic composition of claim 1, wherein said non-reactive component is present in an amount of from 10 percent by weight to 40 percent by weight, based on total resin solids of said curable photochromic composition.

14. The curable photochromic composition of claim 1, wherein said photochromic compound (a) comprises at least one of of naphthopyrans, benzopyrans, phenanthropyrans, indenonaphthopyrans, spiro(indoline) naphthoxazines, spiro(indoline)pyridobenzoxazines, spiro(benzindoline)pyridobenzoxazines, spiro(benzindoline) naphthoxazines, spiro(indoline)-benzoxazines, fulgides, fulgimides, or diarylethenes.

15. An article comprising:
(A) a substrate; and
(B) a photochromic layer over at least one surface of the substrate, wherein the photochromic layer is formed from the curable photochromic composition of claim 1.
